(19) United States
(12) Patent Application Publication
(10) Pub. No.: US 2018/0220820 A1
(43) Pub. Date: Aug. 9, 2018

(54) Illuminated Beverage Cooler

(71) Applicant: Howard Shelton, Las Vegas, NV (US)

(72) Inventor: Howard Shelton, Las Vegas, NV (US)

(21) Appl. No.: 15/427,209

(22) Filed: Feb. 8, 2017

(51) Int. Cl. A47G 23/02; B65D 81/38; F21L 4/00; F21V 23/04

(52) U.S. Cl. CPC A47G 23/0216; B65D 81/3876; A47G 2200/08; F21V 23/0414; A47G 2023/0283; F21L 4/00

(57) ABSTRACT

An illuminated beverage cooler includes a cylinder that may have a beverage container inserted therein. The cylinder is comprised of a thermally insulating material to maintain a temperature of the beverage cooler. A lighting unit is coupled to the cylinder and the lighting unit selectively emits light outwardly from the cylinder. The lighting unit is arranged to define indicia.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to cooler devices and more particularly pertains to a new cooler device for emitting a selected pattern of light while insulating a beverage container.

### BRIEF SUMMARY OF THE INVENTION

An embodiment of the disclosure meets the needs presented above by generally comprising a cylinder that may have a beverage container inserted therein. The cylinder is comprised of a thermally insulating material to maintain a temperature of the beverage cooler. A lighting unit is coupled to the cylinder and the lighting unit selectively emits light outwardly from the cylinder. The lighting unit is arranged to define indicia.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an illuminated beverage cooler according to an embodiment of the disclosure.

FIG. 2 is a top view of an embodiment of the disclosure.

FIG. 3 is a front view of an embodiment of the disclosure.

FIG. 4 is a perspective view taken from circle 4 of FIG. 3 of an embodiment of the disclosure.

FIG. 5 is a cross sectional view taken along line 5-5 of FIG. 4 of an embodiment of the disclosure.

FIG. 6 is a phantom perspective in-use view of an embodiment of the disclosure.

### DETAILED DESCRIPTION OF THE INVENTION

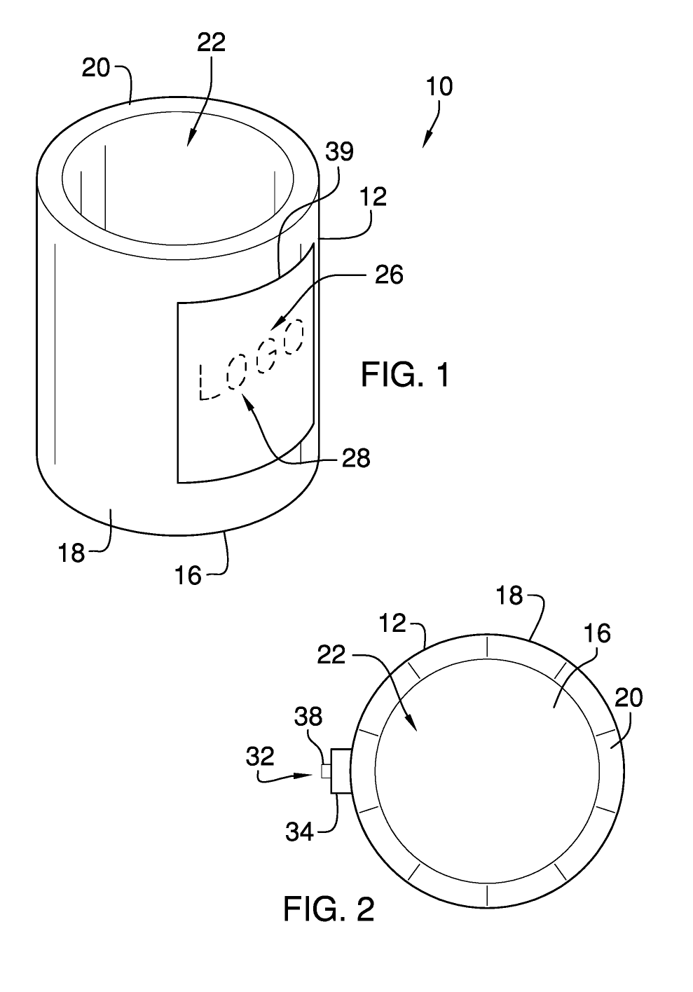

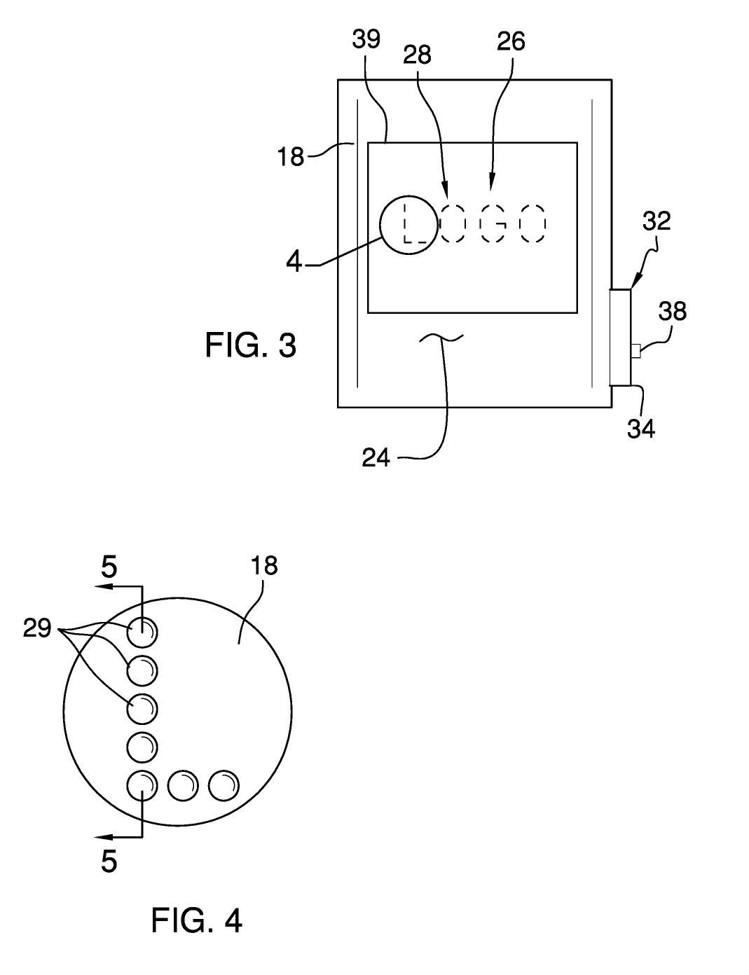

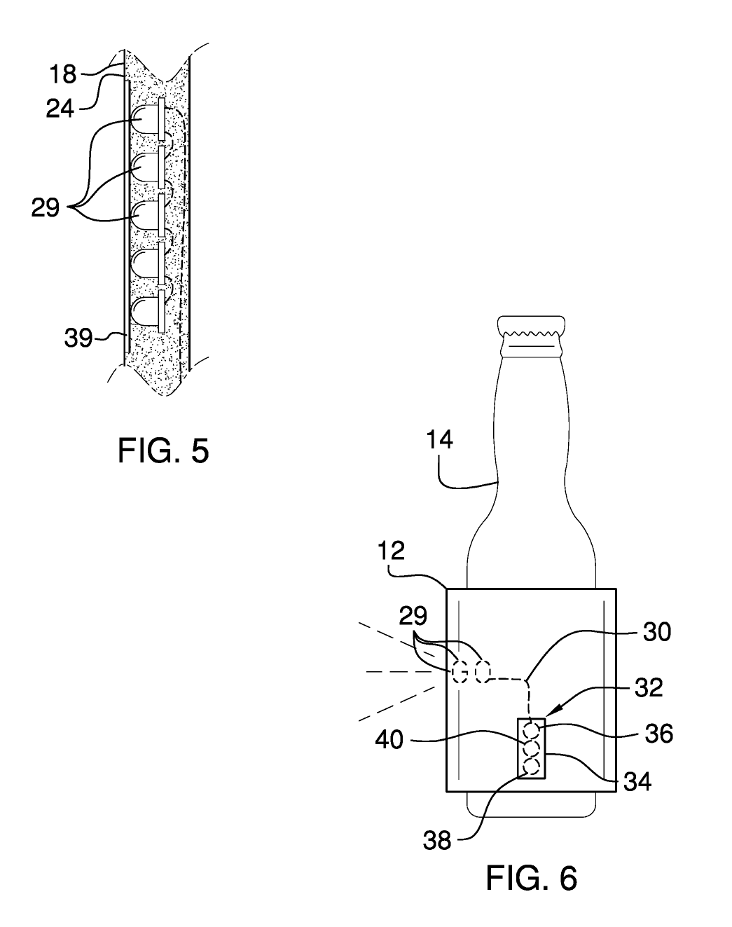

With reference now to the drawings, and in particular to FIGS. 1 through 6 thereof, a new cooler device embodying the principles and concepts of an embodiment of the disclosure and generally designated by the reference numeral 10 will be described.

As best illustrated in FIGS. 1 through 6, the illuminated beverage cooler 10 generally comprises a cylinder 12 that may have a beverage container 14 inserted therein. The beverage container 14 may be a bottle, a can or other beverage container 14. The cylinder 12 is comprised of a thermally insulating material to maintain a temperature of the beverage cooler. The cylinder 12 has a bottom wall 16 and an outer wall 18 extending upwardly therefrom. The outer wall 18 has a distal edge 20 with respect to the bottom wall 16 and the distal edge 20 defines an opening 22 into the cylinder 12. Moreover, the opening 22 insertably receives the beverage container 14 having the outer wall 18 abutting the beverage container 14. The outer wall 18 has an outside surface 24.

A lighting unit 26 is coupled to the cylinder 12 and the lighting unit 26 selectively emits light outwardly from the cylinder 12. The lighting unit 26 is arranged to define indicia 28. The lighting unit 26 comprises a plurality of light emitters 29. Each of the light emitters 29 is embedded in the outer wall 18 and each of the light emitters 29 extends substantially through the cylinder 12. Additionally, the light emitters 29 are positioned to be flush with the outside surface 24 of the cylinder 12. In this way each of the light emitters 29 selectively emits light outwardly from the outer wall 18. Each of the plurality of light emitters 29 may comprise an LED or the like and the plurality of light emitters 29 is arranged to define the indicia 28. The indicia 28 may comprise a selected word, a selected logo or any selected geometric shape.

A plurality of conductors 30 is provided and each of the conductors 30 is embedded within the outer wall 18 of the cylinder 12. Each of the conductors 30 is electrically coupled to an associated one of the light emitters 29. A power supply 32 is coupled to the outer surface of the cylinder 12 and the power supply 32 is electrically coupled to each of the conductors 30.

The power supply 32 comprises a housing 34 that is coupled to and extends outwardly from the outside surface 24 of the cylinder 12. At least one battery 36 is removably positioned within the housing 34 and the at least one battery 36 is electrically coupled to each of the conductors 30. A switch 38 may be provided and the switch 38 may be coupled to the housing 34. The switch 38 may be electrically coupled to the power supply 32 to turn the power supply 32 on and off.

A panel 39 is provided and the panel 39 is coupled to the outside surface 24 of the cylinder 12. The panel 39 is comprised of a translucent material and the panel 39 is aligned with the lighting unit 26. Thus, the plurality of light emitters 29 emits light through the panel 39. Moreover, the panel 39 is positioned to be flush with the outside surface 24 of the cylinder 12. In this way the panel 39 and the cylinder 12 present a continuous surface to enhance gripping the cylinder 12.

A processor 40 is provided and the processor 40 is positioned within the housing 34. The processor 40 is electrically coupled to each of the light emitters 29. Moreover, the processor 40 actuates the plurality of light emitters 29 to sequentially turn on and off thereby facilitating the indicia 28 to have the appearance of motion. The processor 40 may be an electronic processor 40 or the like.

In use, the beverage container 14 is inserted into the cylinder 12 to maintain a temperature of the beverage container 14. A beverage contained within the beverage container 14 is selectively consumed. The light emitters 29 emit light to display the indicia 28 and the processor 40 actuates the light emitters 29 to sequentially illuminate in a predetermined pattern. The beverage container 14 is removed from the cylinder 12 when the beverage in the beverage container 14 is consumed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated beverage cooler being configured to surround a beverage container thereby maintaining a temperature of the beverage cooler, said assembly comprising:
a cylinder being configured to have a beverage container inserted therein, said cylinder being comprised of a thermally insulating material wherein said cylinder is configure to maintain a temperature of the beverage cooler; and
a lighting unit being coupled to said cylinder wherein said lighting unit is configured to emit light outwardly from said cylinder, said lighting unit being arranged to define indicia.

2. The assembly according to claim 1, wherein said cylinder has a bottom wall and an outer wall extending upwardly therefrom, said outer wall having a distal edge with respect to said bottom wall, said distal edge defining an opening into said cylinder wherein said opening is configured to insertably receive the beverage container having said outer wall abutting the beverage container, said outer wall having an outside surface.

3. The assembly according to claim 1, wherein:
said cylinder has an outer wall, said outer wall having an outer surface; and
said lighting unit comprises a plurality of light emitters, each of said light emitters being embedded in said outer wall, each of said light emitters extending substantially through said cylinder wherein each of said light emitters is configured to emit light outwardly from said outer wall, said plurality of light emitters being arranged to define indicia.

4. The assembly according to claim 3, further comprising a plurality of conductors, each of said conductors being embedded within said outer wall of said cylinder, each of said conductors being electrically coupled to an associated one of said light emitters.

5. The assembly according to claim 4, further comprising a power supply being coupled to said outer surface of said cylinder, said power supply being electrically coupled to each of said conductors.

6. The assembly according to claim 5, wherein said power supply comprises a housing being coupled to and extending outwardly from said outer surface of said cylinder.

7. The assembly according to claim 1, further comprising at least one battery being removably positioned within said housing.

8. An illuminated beverage cooler being configured to surround a beverage container thereby maintaining a temperature of the beverage cooler, said assembly comprising:
a cylinder being configured to have a beverage container inserted therein, said cylinder being comprised of a thermally insulating material wherein said cylinder is configure to maintain a temperature of the beverage cooler, said cylinder having a bottom wall and an outer wall extending upwardly therefrom, said outer wall having a distal edge with respect to said bottom wall, said distal edge defining an opening into said cylinder wherein said opening is configured to insertably receive the beverage container having said outer wall abutting the beverage container, said outer wall having an outside surface; and
a lighting unit being coupled to said cylinder wherein said lighting unit is configured to emit light outwardly from said cylinder, said lighting unit being arranged to define indicia, said lighting unit comprising:
a plurality of light emitters, each of said light emitters being embedded in said outer wall, each of said light emitters extending substantially through said cylinder wherein each of said light emitters is configured to emit light outwardly from said outer wall, said plurality of light emitters being arranged to define indicia,
a plurality of conductors, each of said conductors being embedded within said outer wall of said cylinder, each of said conductors being electrically coupled to an associated one of said light emitters, and
a power supply being coupled to said outer surface of said cylinder, said power supply being electrically coupled to each of said conductors, said power supply comprising:
a housing being coupled to and extending outwardly from said outer surface of said cylinder, and
at least one battery being removably positioned within said housing.
